(19) United States
(12) Patent Application Publication
(10) Pub. No.: US 2022/0046931 A1
(43) Pub. Date: Feb. 17, 2022

(54) ELEVATED COUNTERTOP COOKING APPARATUS, SYNCHRONIZED MULTI-BAY COOKING APPARATUS, AND METHOD FOR SYNCHRONIZED MULTI-BAY COOKING

(71) Applicant: ENNOVATE INC., Vaughan (CA)

(72) Inventors: Salvatore Albano IANTORNO, Vaughan (CA); Jonathan LOUDON, Toronto (CA); Julian RICHARDSON, Miller Lake (CA); Jason MACDONALD, Toronto (CA)

(21) Appl. No.: 17/470,593

(22) Filed: Sep. 9, 2021

Related U.S. Application Data
(63) Continuation of application No. PCT/CA2021/050435, filed on Mar. 31, 2021.
Application No. PCT/CA2021/050435 is a continuation-in-part of application No. 16/835,676, filed on Mar. 31, 2020.
(60) Provisional application No. 63/199,232, filed on Dec. 15, 2020.

(51) Int. Cl. A21B 1/52; F24C 7/08; A47J 37/06; A47J 36/32; A23L 5/10

(52) U.S. Cl. CPC A21B 1/52; F24C 7/087; A23V 2002/00; A47J 36/32; A23L 5/15; A47J 37/0629

(57) ABSTRACT

There is provided a cooking apparatus for cooking multiple food items, including: a housing including multiple separate cooking bays; a control module communicatively linked to each of the cooking bays to receive or determine a cooking time and cooking temperature for the food item received by the respective cooking bay; and a coordination module configured to: determine a total cooking time for each of a plurality of the cooking bays; determine the cooking bay with the longest associated cooking time; determine an offset of the start of the cooking process for each of the other cooking bays such that the cooking times of all the cooking bays end approximately simultaneously; and at each determined offset, direct the respective cooking bay to start the cooking process at the cooking temperature.

### TECHNICAL FIELD

The following relates generally to cooking apparatuses, and more specifically, to an elevated countertop cooking apparatus, a synchronized multi-bay cooking apparatus, and a method for synchronized multi-bay cooking.

### BACKGROUND

Countertop cooking apparatuses are useful devices to cook food items without having to engage large, energy expensive, apparatuses like full ovens. Countertop cooking apparatuses are generally portable and more energy efficient, especially for cooking smaller food items. However, in many kitchens and cooking establishments, countertop area is at a premium, and thus the use of countertop cooking apparatuses may be limited. Additionally, especially for unexperienced home cooks, timing the cooking processes of multiple cooking apparatuses, each having a separate foodstuff, can be very challenging; and often results in food finishing at suboptimal times.

### SUMMARY

In an aspect, there is provided a cooking apparatus for cooking food items, the cooking apparatus dimensioned to be placed on a kitchen countertop, the cooking apparatus comprising: a housing comprising a top side, a bottom side, a front side, a rear side, a first elevated side, and a second elevated side; a plurality of cooking compartments each defining a cooking cavity and comprising a heating element, each cooking compartment defining an opening to the cooking cavity for receiving one or more of the food items to be cooked by the respective heating element, the respective openings of the cooking compartments are vertically spaced along the front side in a stacked arrangement; and a cooking control to control operation of the cooking compartments.

In a particular case, the area of the bottom side is less than the area of the front side.

In another case, the bottom side is equal to or less than half the area of the front side.

In yet another case, a door is affixed to each opening to restrict access to the cooking compartment.

In yet another case, each cooking compartment comprises an automated turntable to rotate food items.

In yet another case, each cooking compartment comprises an urging mechanism for urging the food item towards the opening.

In yet another case, the heating element comprises at least one of radiant heating coils, a ceramic heater, a halogen cooking lamp, and a sheath heater.

In yet another case, each cooking compartment comprises a convection fan directed to blow air over the heating element or the food item, or both.

In another aspect, there is provided a cooking apparatus for cooking multiple food items, the cooking apparatus comprising: a housing comprising multiple separate cooking bays, each cooking bay comprising a compartment with a heating element for cooking food items; a control module communicatively linked to each of the cooking bays to receive or determine a cooking time and cooking temperature for the food item received by the respective cooking bay; and a coordination module configured to: determine a total cooking time for each of a plurality of the cooking bays; determine the cooking bay with the longest associated cooking time; determine an offset of the start of the cooking process for each of the other cooking bays such that the cooking times of all the cooking bays end approximately simultaneously; and at each determined offset, direct the respective cooking bay to start the cooking process at the cooking temperature.

In a particular case of the cooking apparatus, the cooking times for each of the cooking bays are received from a user.

In another case of the cooking apparatus, each of the cooking times can be determined by retrieving the cooking times from a database of predetermined cooking times, based on a food item to be cooked in the respective cooking bay and based on a cooking type for the respective cooking bay.

In yet another case of the cooking apparatus, the cooking times of the cooking process comprise time to preheat the cooking bay and time to complete cooking of a food item in the cooking bay.

In another case of the cooking apparatus, the cooking apparatus further comprising an output device, and wherein the output device outputs an indication to a user that preheating has finished for the user to insert the food item into the respective cooking bay.

In another case of the cooking apparatus, approximately simultaneously comprises end times of cooking times of the cooking bays being within one minute of each other.

In another case of the cooking apparatus, the cooking apparatus further comprising a temperature probe associated with one or more cooking bays, and wherein the control module adjusts the cooking time for each cooking bay based on the rate of increase of temperature of the food item in the respective cooking bay.

In another aspect, there is provided a method for cooking multiple food items in a single cooking apparatus comprising multiple cooking bays, the method comprising: receiving or determining a cooking time and cooking temperature for the food item received by each respective cooking bay; determining a total cooking time for each of a plurality of the cooking bays; determining the cooking bay with the longest associated cooking time; determining an offset of the start of the cooking process for each of the other cooking bays such that the cooking times of all the cooking bays end approximately simultaneously; and at each determined offset, directing the respective cooking bay to start the cooking process at the cooking temperature.

In a particular case of the method, the method further comprising receiving the cooking times for each of the cooking bays from a user.

In another case of the method, the method further comprising retrieving the cooking times from a database of predetermined cooking times, based on a food item to be cooked in the respective cooking bay and based on a cooking type for the respective cooking bay.

In yet another case of the method, the cooking times of the cooking process comprise time to preheat the cooking bay and time to complete cooking of a food item in the cooking bay.

In yet another case of the method, the method further comprising adjusting the cooking time for each cooking bay based on a rate of increase of temperature of the food item in the respective cooking bay.

These and other aspects are contemplated and described herein. It will be appreciated that the foregoing summary sets out representative aspects of the embodiments to assist skilled readers in understanding the following detailed description.

### DESCRIPTION OF THE DRAWINGS

A greater understanding of the embodiments will be had with reference to the Figures, in which:

FIG. 1 illustrates a front perspective view of an embodiment of an elevated countertop cooking apparatus;

FIG. 2 illustrates a front elevation view of the elevated countertop cooking apparatus of FIG. 1;

FIG. 3 illustrates a rear elevation view of the elevated countertop cooking apparatus of FIG. 1;

FIG. 4 illustrates a top view of the elevated countertop cooking apparatus of FIG. 1;

FIGS. 5A to 5G illustrate front elevation views of other respective embodiments of the elevated countertop cooking apparatus;

FIG. 6A illustrates a front perspective view of an embodiment of synchronized multi-bay cooking apparatus with cooking bay compartment doors closed;

FIG. 6B illustrates a front perspective view of the synchronized multi-bay cooking apparatus of FIG. 6A with cooking bay compartment doors open;

FIG. 7 illustrates a cutaway front perspective view of the synchronized multi-bay cooking apparatus of FIG. 6A;

FIG. 8 illustrates a flowchart for a method for synchronized multi-bay cooking, in accordance with an embodiment; and

FIG. 9 illustrates an example of a coordination module, in accordance with the synchronized multi-bay cooking apparatus of FIG. 6A.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The following relates generally to cooking apparatuses, and more specifically, to an elevated countertop cooking apparatus, a synchronized multi-bay cooking apparatus, and a method for synchronized multi-bay cooking.

The cooking apparatus of the embodiments described herein advantageously provides multiple cooking compartments in an elevated arrangement. This arrangement significantly reduces countertop footprint, while allowing multiple food items to be cooked simultaneously, and in some cases, independently. In many kitchens and cooking establishments where countertop area is at a premium, the present embodiments provide a substantially advantageous solution for applications that require multiple cooking chambers.

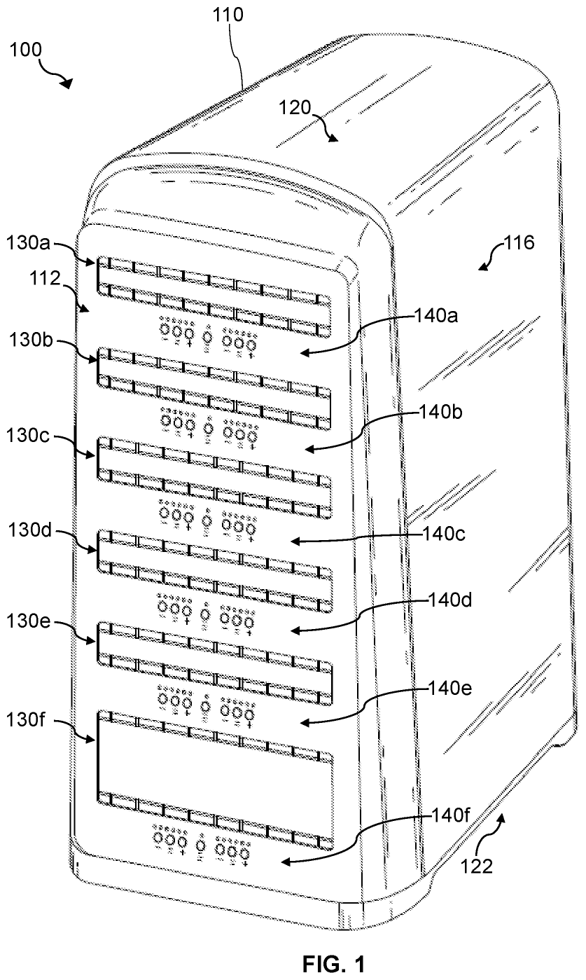

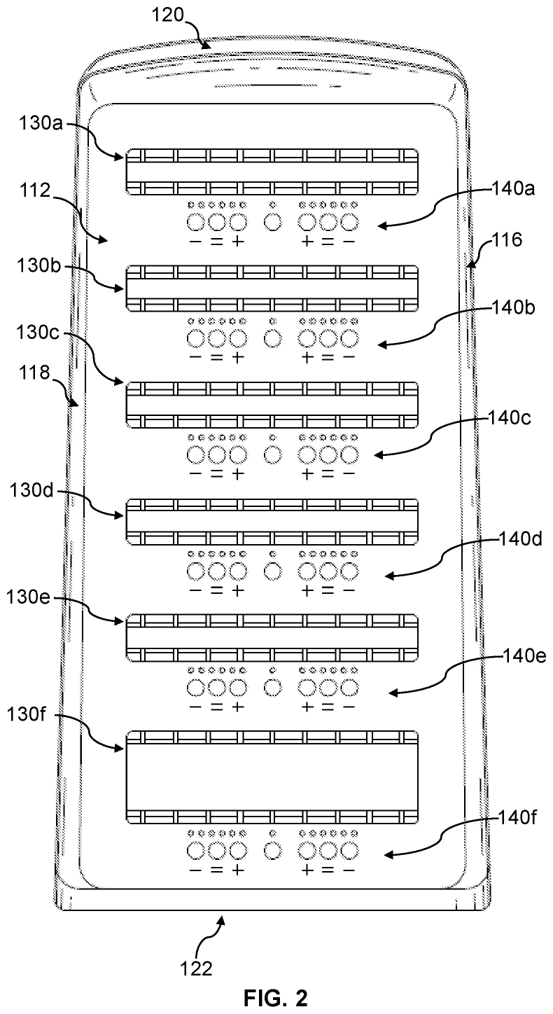

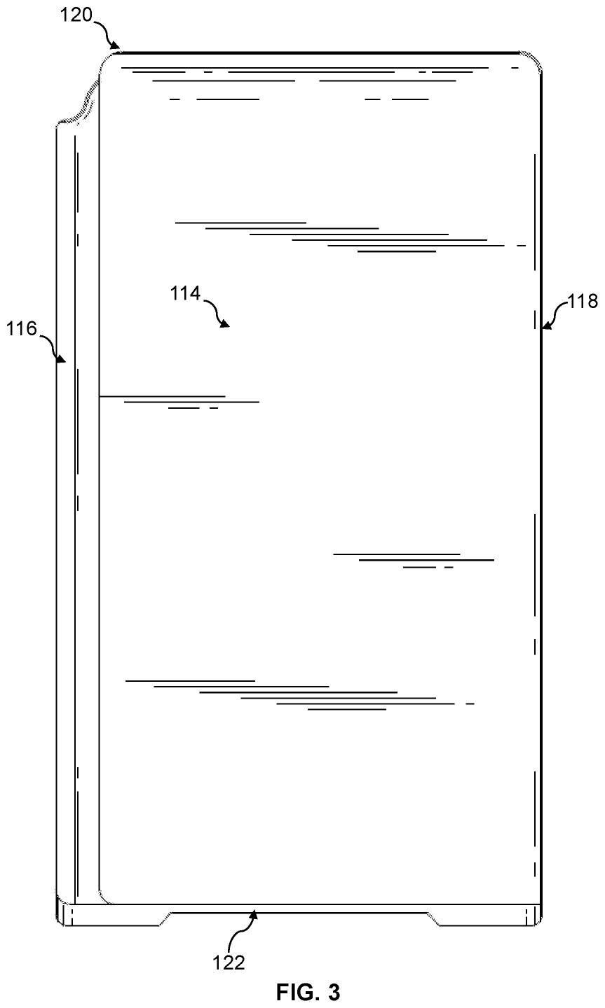

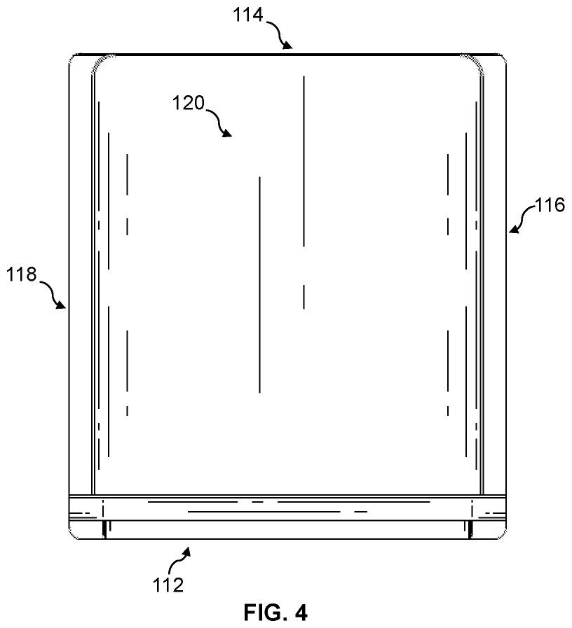

Turning to FIG. 1, a front perspective view of an embodiment of an elevated countertop cooking apparatus 100 is illustrated. FIG. 2 illustrates a front elevation view, FIG. 3 illustrates a rear elevation view, and FIG. 4 illustrates a top view of the elevated countertop cooking apparatus 100.

The cooking apparatus 100 includes a housing 110 having a front side 112, a rear side 114, a first elevated side 116, and a second elevated side 118, a top side 120, and a bottom side 122. In the embodiment of FIGS. 1 to 4, the bottom side 122 has an area that is slightly larger than the top side 120 due to tapering as the elevation increases; however, in further cases, the top side 120 can be the same area, or have a greater area, than the bottom side 122. In the present embodiments, the area of the bottom side 122 is less than the area of the front side 112; as an example, the bottom side 122 can be approximately half the area of the front side 112, three-quarters the area of the front side 112, or the like. In this way, the countertop area required by the cooking apparatus 100, defined by the area of the bottom side 122, is less than the area required to provide multiple cooking compartments, which are located on the front side 112. The present embodiments can have any suitable width, depth, and height as long as the cooking apparatus is dimensioned to be suitably placeable on a kitchen countertop.

The front side 112 includes multiple cooking compartments 130. In the embodiments of FIGS. 1 to 4, there are six cooking compartments 130a to 130f, respectively. The cooking compartments 130 are arranged in a vertically stacked arrangement, where each cooking compartment 130 is spaced relative to other cooking compartments 130 along the vertical. In this way, multiple cooking compartments 130 can be included without increasing the countertop footprint.

Each cooking compartment 130 includes an opening on the front side 112 for receiving a food item to be cooked, and for retrieving such food item after cooking. In some cases, a door or flap (not shown) can be affixed to the opening to restrict access to the cooking compartment 130, such as while the food is cooking. The cooking compartments 130, and by extension the respective openings, can be any suitable size; for example, the embodiment of FIGS. 1 to 4 includes two sizes of cooking compartments 130, a first size of compartments 130a, 130b, 130c, 130d, 130e and a larger second size of compartment 130f. In some cases, the size of the cooking compartments 130, and their respective openings, can be sized for particular food items to be cooked (for example bread slices) or sized for certain cooking utensils (for example, an associated baking tray).

The cooking compartments 130 can have any suitable interior construction, for example, constructed out of aluminum, stainless steel, or heat resistant polymer. In some cases, the cooking compartments 130 can include an automated turntable for rotating food items inside the cavity. In some cases, the cooking compartments 130 can include an urging mechanism, for example a spring releasable carriage, for urging the food item towards the opening after the cooking process has completed.

The cooking compartments 130 can heat and cook food items using any suitable heating element or heating approach. For example, including radiant heating coils inside or adjacent to the cooking compartment 130. In further cases, a ceramic heater, halogen cooking lamp, sheath heater, or the like, can be used. In some cases, a convection fan can be provided in the cooking compartment 130 directed to blow air over the heating element and/or the food items. In some cases, multiple types of heating elements can be used for each cooking compartment 130.

In the embodiment of FIGS. 1 to 4, each cooking compartment 130 is controlled by a separate cooking control 140a to 140f. Each cooking control 140 controls the operation of the respective cooking compartment 130, such as operation status, duration, temperature, and the like. In some cases, each cooking control 140 can include an output device, such as LED lights, an LED display, or a touchscreen, to indicate to a user the status, or aspects, of the cooking process. In some cases, each cooking control 140 can include an input device, such as buttons or a touchscreen, to allow the user to initiate the cooking process and, in some cases, control aspects of the cooking process. In further cases, a single cooking control 140 can control multiple, or all, cooking compartments 130. In further cases, other cooking controls 140 can be used; for example remote control of the cooking compartments using an app on a smartphone communicating with a receiver or computing device associated with control over each, or all, of the cooking compartments 130.

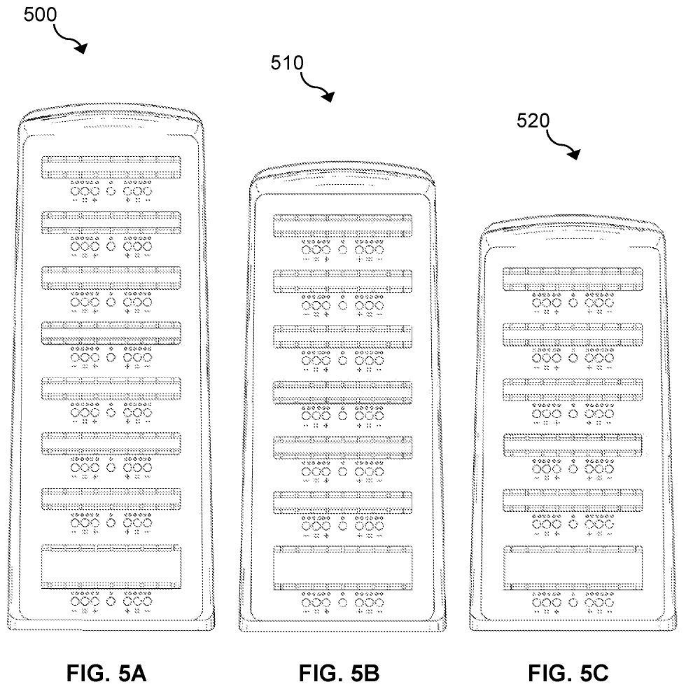

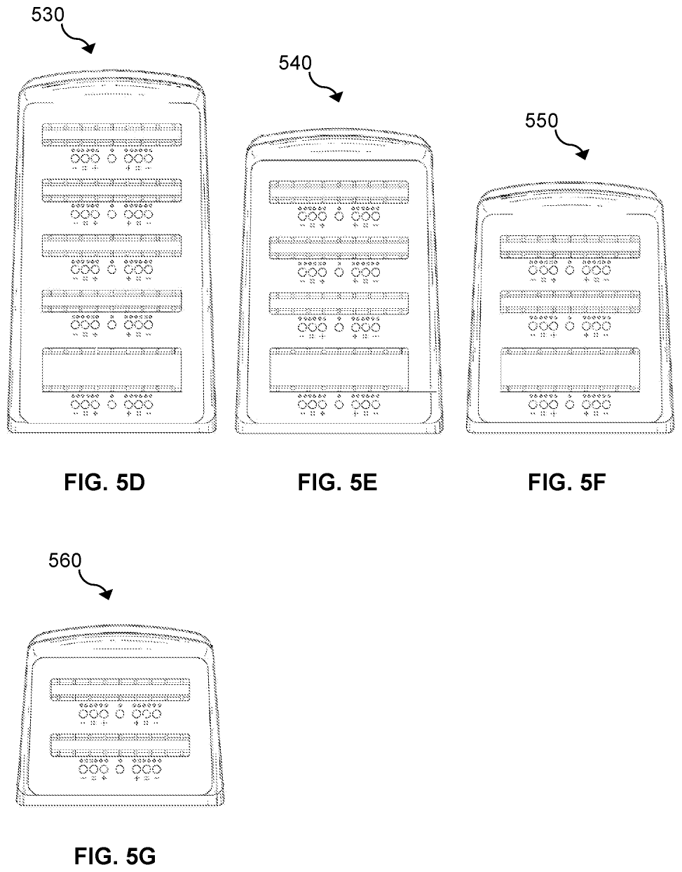

FIGS. 5A to 5G illustrate front elevation views of other respective embodiments of the elevated countertop cooking apparatus 500, 510, 520, 530, 540, 550, and 560 respectively. As illustrated, different quantities, types, and configurations of cooking compartments 130 are contemplated as part of the various embodiments. While the present embodiments illustrate between two and eight cooking compartments 130, any suitable quantity of vertically separated cooking compartments 130 can be used.

In another embodiment, the cooking apparatus with multiple compartment arrangement advantageously allows the cooking apparatus to provide a compact arrangement with coordinated and/or synchronized cooking times and/or completion times for each cooking bay. Thus, such embodiments, having a single apparatus with multiple cooking bays, eliminate the substantial difficulty of getting multiple separate cooking devices to communicate and coordinate with each other effectively.

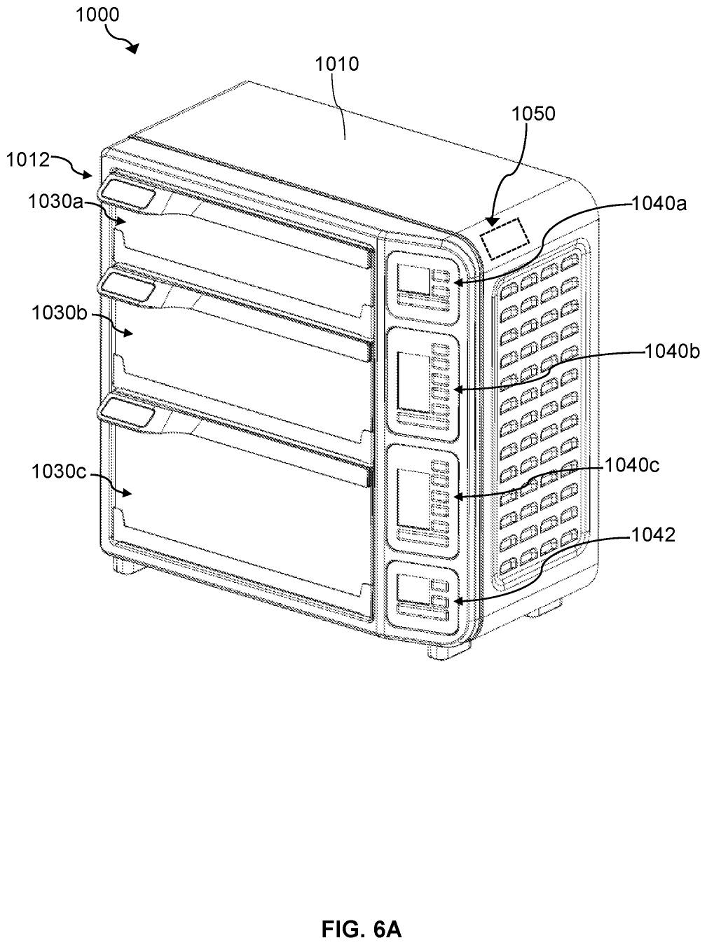

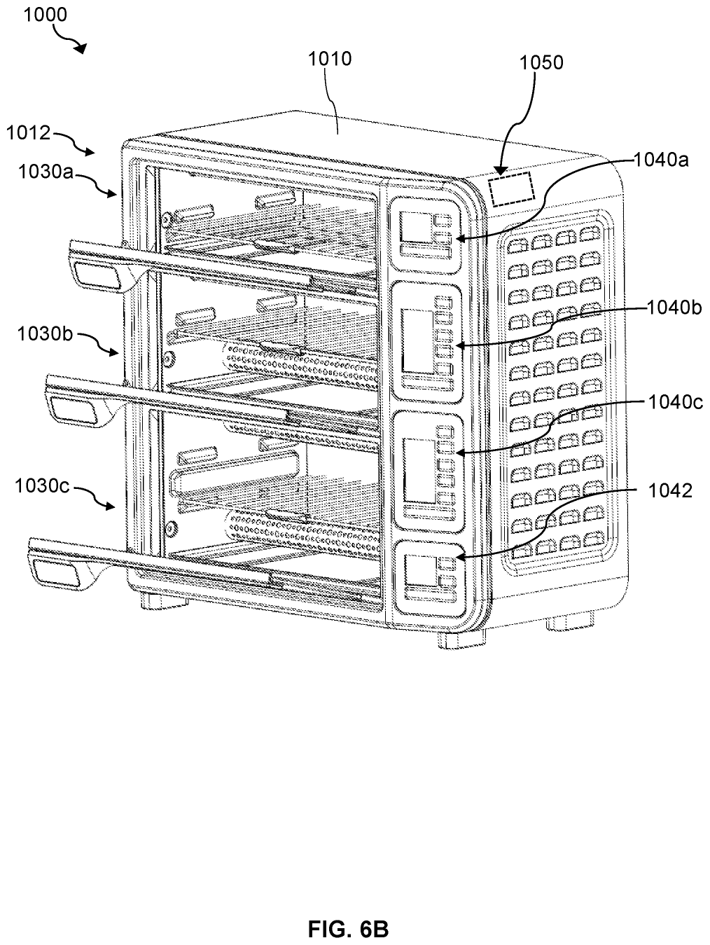

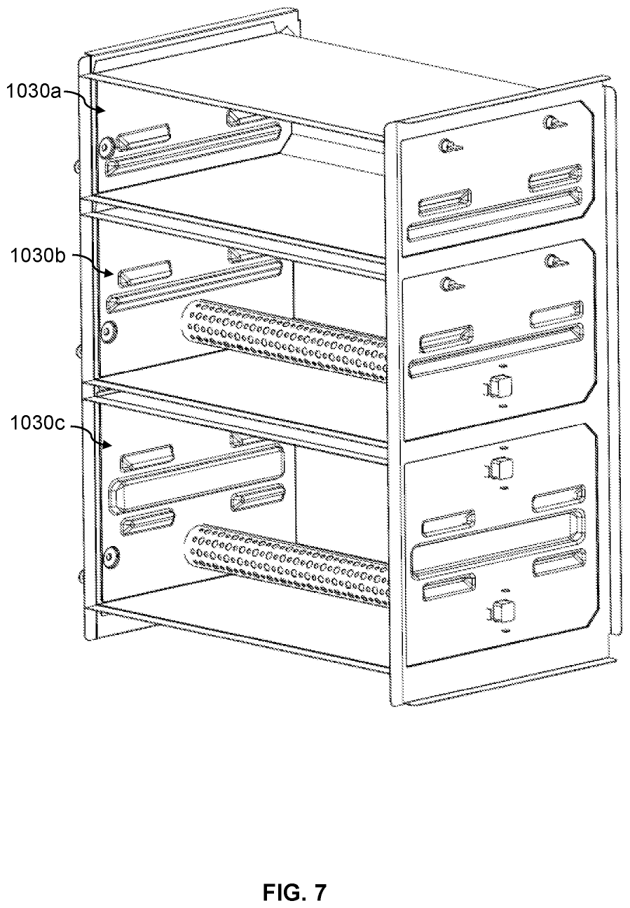

Turning to FIGS. 6A and 6B, front perspective views of an embodiment of synchronized multi-bay cooking apparatus 1000 are illustrated, shown with cooking bay compartment doors closed and open, respectively. FIG. 7 illustrates a cutaway view of the interior of the synchronized multi-bay cooking apparatus 1000 exemplified in FIGS. 6A and 6B.

The synchronized multi-bay cooking apparatus 1000 includes a housing 1010 having a front side 1012 with multiple cooking bays 1030; in this embodiment, there are three cooking bays 1030a, 1030b, 1030c. The cooking bays 1030 are arranged in a vertically stacked arrangement, where each cooking bay 1030 is spaced relative to other cooking bays 1030 along the vertical. In this way, multiple cooking bays 1030 can be included without increasing the countertop footprint. In further embodiments, the synchronized multi-bay cooking apparatus 1000 can have any suitable number and arrangement of cooking bays.

In the present embodiment of FIGS. 6A and 6B, the area of the bottom of the housing 1010 is less than the area of the front side 1012, such that the countertop-area/floorspace required by the synchronized multi-bay cooking apparatus 1000, defined by the area of the bottom side, is less than the area required to provide multiple cooking compartments, which are located on the front side 1012. However, any suitable dimensioning of the synchronized multi-bay cooking apparatus 1000 can be used.

Each cooking bay 1030 includes an opening for receiving a food item to be cooked, and for retrieving such food item after cooking. In some cases, a door or flap can be affixed to the opening to restrict access to the cooking bay 1030, such as while the food is cooking. The cooking bays 1030, and by extension the respective openings, can be any suitable size. In some cases, the size of the cooking bays 1030, and their respective openings, can be sized for particular food items to be cooked (for example bread slices) or sized for certain cooking utensils (for example, an associated baking tray).

The cooking bays 1030 can have any suitable interior construction, for example, constructed out of aluminum, stainless steel, or heat resistant polymer. In some cases, the cooking bays 1030 can include an automated turntable for rotating food items inside the cavity. In some cases, the cooking bays 1030 can include an urging mechanism, for example a spring releasable carriage, for urging the food item towards the opening after the cooking process has completed.

The cooking bays 1030 can heat and cook food items using any suitable heating element or heating approach. For example, including radiant heating coils inside or adjacent to the cooking bay 1030. In further cases, a ceramic heater, halogen cooking lamp, sheath heater, or the like, can be used. In some cases, a convection fan can be provided in the cooking bay 1030 directed to blow air over the heating element and/or the food items. In some cases, multiple types of heating elements can be used for each cooking bay 1030.

It is contemplated that the synchronized multi-bay cooking apparatus 1000 can comprise different quantities, types, and configurations of cooking bays 1030 as part of various embodiments.

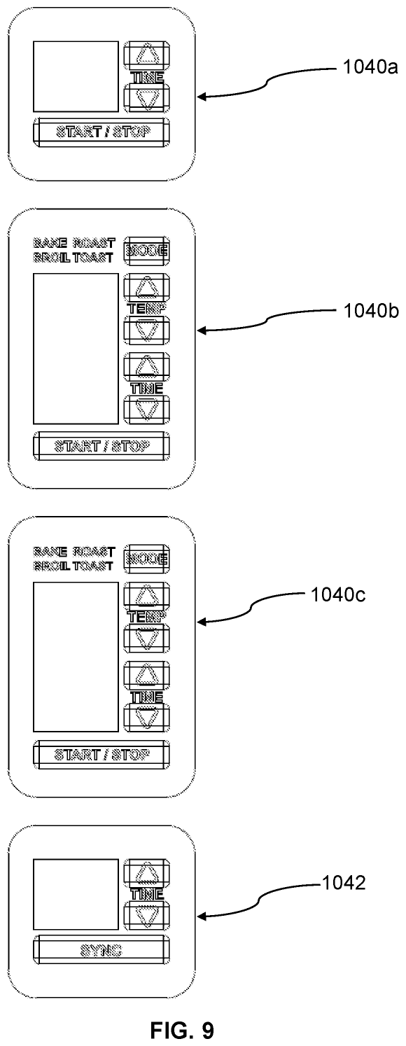

In the embodiment of FIGS. 6A and 6B, each cooking bay 1030 is controlled by a respective cooking control module 1040a to 1040c; an example of which is illustrated in greater detail in FIG. 9. Each cooking control module 1040 controls aspects of operation of the respective cooking bay 1030. Each cooking control module 1040 can include an output device, for example LED lights, an LED display, LCD display, or a touchscreen, to indicate to a user the status, or aspects, of the cooking process. In some cases, each cooking control 1040 can include an input device, such as buttons or a touchscreen, to receive input from a user to determine at least some of the aspects of operation. In further cases, a single cooking control module 1040 can control multiple, or all, cooking bays 1030. In further cases, other cooking control modules 1040 can be used; for example remote control of the cooking compartments using an app on a smartphone communicating with a receiver or computing device associated with control over each, or all, of the cooking bays 1030.

In an example, the aspects of operation can include cooking type, for example, bake, roast, broil, toast, and the like. In another example, the aspects of operation can include temperature of cooking and/or cooking time. In another example, the aspects of operation can include starting and stopping of the cooking.

In the embodiment of FIGS. 6A and 6B, the synchronized multi-bay cooking apparatus 1000 includes a coordination module 1042; an example of which is illustrated in greater detail in FIG. 9. The coordination module 1042 can communicate with the cooking bays 1030 and be used to synchronize cooking of the separate cooking bays 1030, and in some cases, to delay the cooking process in one or more of the cooking bays 1030. In further cases, the coordination module 1042 can be combined with, or part of, one or more of the cooking control modules 1040. Advantageously, the synchronization can address the substantial problem for many home and professional cooks of to control multiple different cooking times and multiple different temperatures in order to produce different cooked products at the same time.

The coordination module 1042 and the cooking control modules 1040 can comprise any suitable electronic architecture, for example, a central-processing unit, a microprocessor, a microcontroller, an application specific integrated circuit (ASIC), a field programmable gate array (FPGA), or the like. In some cases, a centralized electronic architecture can execute the functions of each of the cooking control modules 1040 and the coordination module. The electronic architecture generally includes an associated data store; for example, volatile data storage and/or a non-volatile data storage. During operation, the modules, and the related data may be retrieved from the non-volatile storage and placed in volatile storage to facilitate execution. The modules can communicate with each other, and/or a centralized architecture and data store, using any suitable communication scheme, interface, or architecture.

In some cases, as illustrated in FIG. 9, the coordination module 1042, the cooking control modules 1040, or both, can include a user interface that enables a user to provide input via an input device, for example, physical buttons or a touchscreen. The user interface can also output information to output devices to the user, such as a display and/or speakers. In some cases, the modules 1042, 1040 can include a network interface to permit communication with other systems, such as a user's smartphone or other computing devices.

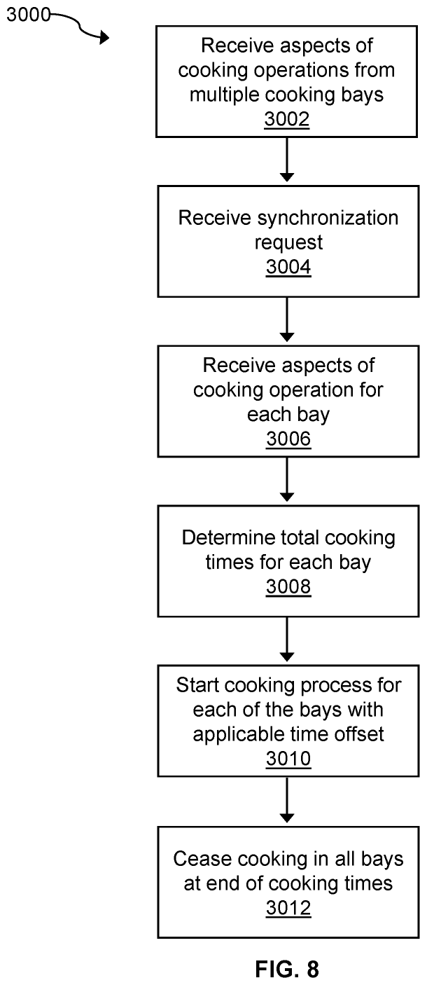

Turning to FIG. 8 shown therein is a method 3000 for synchronized multi-bay cooking, in accordance with an embodiment. At block 3002, the synchronized multi-bay cooking apparatus 1000 receives aspects of operation of for two or more of the cooking bays 1030, from each cooking bay's respective control module 1040. The aspects of operation received include, at least, cooking time and cooking temperature for each cooking bay 1030.

At block 3004, the coordination module 1042 receives an input from the user indicating synchronization of the cooking bays 1030 is requested. At block 3006, the coordination module 1042 receives the cooking times and cooking temperature from each of the control modules 1040 which received input from the user. At block 3008, for each of such cooking bays 1030, the coordination module 1042 determines a preheating time to reach the received cooking time using a predetermined reference or database of preheating times. The coordination module 1042 determines a total cooking time by combining the preheating time with the received cooking time. At block 3010, the coordination module 1042 determines the cooking bay 1030 with the longest associated total cooking time, and starts preheating that cooking bay first. The coordination module 1042 subtracts the total cooking time associated with each other cooking bay 1030 from the longest total cooking time to determine an associated time offset. Each of the other cooking bays 1030 start preheating after the associated time offset. In this way, each of the food items in each of the cooking bays 1030 finishes cooking at approximately or around the same time. An acceptable difference in end times for the cooking bays can be based on the preciseness of the user's requirements; for example, in a home setting, having the cooking bays finish within a minute of each other. In some cases, each cooking control 1040 can output an indication to the user when the associated cooking bay 1030 has finished preheating such that the user can insert the food item into the cooking bay 1030 at that time.

At block 3012, the cooking control 1040 for each cooking bay 1030 can cease cooking and the cooking controls 1040 and/or the coordination module 1042 can indicate to the user that the cooking process has finished such that they can remove their cooked food items.

In further cases, the cooking bays 1030 can be preheated at the same time, and accordingly, the total cooking time for each cooking bay 1030 will only comprise the received cooking time. In these cases, the cooking time for each cooking bay 1030 starts after all the cooking bays 1030 have preheated.

In further cases, the cooking controls 1040 and/or the coordination module 1042 can store a database of food items and their associated approximate cooking times according to a particular preparation or recipe. In this way, the user can input the cooking item to the cooking control 1040, in some cases with a preparation and/or doneness, and the cooking control 1040 and/or the coordination module 1042 will look up the associated cooking temperature and cooking time in the database.

In further cases, the coordination module 1042 can delay the preheating process, and/or the cooking time start, by a set delay received as input from the user.

In further cases, the coordination module 1042 can determine the cooking time using a temperature probe in the food item, and make cooking time adjustments accordingly. In an example, a food item in one of the cooking bays 1030a can be a chicken breast that the user inputs they would like to reach 165 degrees Fahrenheit and a food item in another cooking bay 1030b can be a potato that user inputs they would like to reach 210 degrees Fahrenheit. Initially, the coordination module 1042 can predict the cooking time for both items using a database of cooking times for chicken and potato, using a user's inputted initial cooking time estimate, or using a known temperature rate of change for each cooking bay 1030. The coordination module 1042 can delay starting of the cooking bay 1030 with the shorter cooking time by a time offset as described for the method 3000. As the temperature of each food item rises, the coordination module 1042 can use the rate of change of each food item to adjust the prediction for the end of cooking time. The coordination module 1042 can then reduce or increase the temperature of the respective cooking bay 1030 in order to slow or increase the rate of temperature rise such that the two food items will arrive at their desired temperature at around the same time. This feedback control loop, comprising modifying the cooking temperatures, can be repeated periodically to ensure that the cooking times of the cooking bays 1030 end at around the same time.

In some cases, a load-balancing module 1050 can be used to ensure that the total electrical load of the bays do not exceed capacity of an electrical supply circuit. In an example, if the multi-bay cooking apparatus 1000 is plugged into a 15-amp circuit, the load-balancing module 1050 can continuously or periodically measure the amperage draw from each of heating elements of each cooking bay 1030. When the total amperage draw approaches the 15-amp limit, for example when it reaches 13 amps, the load-balancing module 1050 instructs the cooking control module 1040 associated with one or more of the cooking bays 1030 (for example, to the cooking bay 1030 that is currently drawing the most current) to turn off or reduce the amount of electrical current used. In some cases, the coordination module 1042 can adjust the associated cooking time for the load-balanced cooking bays 1040 for the purposes of synchronization.

In some cases, each cooking bay 1030 can include a variable element control mode, controlled by the coordination module 1042, the respective cooking control 1040, or both. This variable element control mode allows for programming of different cooking techniques within each cooking bay 1030. In an example, one or more of the bays can have two different heat modes, a baking mode with a top and underside heating element active and a broil mode with only the top heating element active. In this example, an illustrative cooking cycle could start in broil mode at 450° F. to sear the food for ten minutes, then go to bake mode at 350° F. for forty minutes to slow cook for a longer period of time. In it understood that other heat modes can be used as appropriate; for example, convection modes, warming modes, proofing modes, modes with other selections of heating elements active, and the like. The coordination module 1042 will take into consideration the time for each mode when coordinating syncing of the multiple cooking bays 1030.

In some cases, the variable element control mode can be based on input received from the user with respect to temperature, time, and order of each of the modes. In other cases, there can be pre-set modes to be selected by the user; as an example, a “crispy pizza” pre-set mode that bakes at 450° F. for 15 minutes, then only the underside heating element is active at 550° F. to crisp up the bottom of the pizza.

Although the foregoing has been described with reference to certain specific embodiments, various modifications thereto will be apparent to those skilled in the art without departing from the spirit and scope of the invention as outlined in the appended claims.

1. A cooking apparatus for cooking multiple food items, the cooking apparatus comprising:
a housing comprising multiple separate cooking bays, each cooking bay comprising a compartment with a heating element for cooking food items;
a control module communicatively linked to each of the cooking bays to receive or determine a cooking time and cooking temperature for the food item received by the respective cooking bay; and
a coordination module configured to:
determine a total cooking time for each of a plurality of the cooking bays;
determine the cooking bay with the longest associated cooking time;
determine an offset of the start of the cooking process for each of the other cooking bays such that the cooking times of all the cooking bays end approximately simultaneously; and
at each determined offset, direct the respective cooking bay to start the cooking process at the cooking temperature.

2. The cooking apparatus of claim 1, wherein the cooking times for each of the cooking bays are received from a user.

3. The cooking apparatus of claim 1, wherein each of the cooking times can be determined by retrieving the cooking times from a database of predetermined cooking times, based on a food item to be cooked in the respective cooking bay and based on a cooking type for the respective cooking bay.

4. The cooking apparatus of claim 1, wherein the cooking times of the cooking process comprise time to preheat the cooking bay and time to complete cooking of a food item in the cooking bay.

5. The cooking apparatus of claim 4, further comprising an output device, and wherein the output device outputs an indication to a user that preheating has finished for the user to insert the food item into the respective cooking bay.

6. The cooking apparatus of claim 1, wherein approximately simultaneously comprises end times of cooking times of the cooking bays being within one minute of each other.

7. The cooking apparatus of claim 1, further comprising a temperature probe associated with one or more cooking bays, and wherein the control module adjusts the cooking time for each cooking bay based on the rate of increase of temperature of the food item in the respective cooking bay.

8. A method for cooking multiple food items in a single cooking apparatus comprising multiple cooking bays, the method comprising:
receiving or determining a cooking time and cooking temperature for the food item received by each respective cooking bay;
determining a total cooking time for each of a plurality of the cooking bays;
determining the cooking bay with the longest associated cooking time;
determining an offset of the start of the cooking process for each of the other cooking bays such that the cooking times of all the cooking bays end approximately simultaneously; and
at each determined offset, directing the respective cooking bay to start the cooking process at the cooking temperature.

9. The method of claim 8, further comprising receiving the cooking times for each of the cooking bays from a user.

10. The method of claim 8, further comprising retrieving the cooking times from a database of predetermined cooking times, based on a food item to be cooked in the respective cooking bay and based on a cooking type for the respective cooking bay.

11. The method of claim 10, wherein the cooking times of the cooking process comprise time to preheat the cooking bay and time to complete cooking of a food item in the cooking bay.

12. The method of claim 8, further comprising adjusting the cooking time for each cooking bay based on a rate of increase of temperature of the food item in the respective cooking bay.
